(19) United States
(12) Patent Application Publication
(10) Pub. No.: US 2008/0305683 A1
(43) Pub. Date: Dec. 11, 2008

(54) STRUCTURE FOR HDMI CONNECTOR

(75) Inventors: Jun Li, San-Tai County (CN); Yi-Bin Lee, Taichung County (TW); Chih-Fong Huang, Pingtung City (TW); Shang-Te Ke, Sinjhuang City (TW)

Correspondence Address: PAI PATENT & TRADEMARK LAW FIRM, 1001 FOURTH AVENUE, SUITE 3200, SEATTLE, WA, 98154, US

(73) Assignee: COMOSS ELECTRONIC CO., LTD., Shulin (TW)

(21) Appl. No.: 11/761,192

(22) Filed: Jun. 11, 2007

(51) Int. Cl. H01R 13/648

(52) U.S. Cl. 439/607; 439/497; 439/609; 439/939

(57) ABSTRACT

An improved structure for HDMI connector comprises a resilient buckle plate embedded on a side of a HDMI connector and a containing space formed in front of the resilient buckle plate, said resilient buckle plate having a plurality of retaining blocks disposed on a front end thereof and protruding out of said HDMI connector. Said containing space is disposed for a protruding portion at a front end of a resilient plate of a socket for HDMI connector to buckle up with. When plugging said HDMI connector into a common socket for HDMI connector, as said HDMI connector goes to the latched position inside said socket, said retaining blocks of said resilient buckle plate are buckled at an opening of said socket for HDMI connector to let said HDMI connector and said socket fixedly buckle up with each other. This improved structure can be used with any kind of sockets for HDMI connector.

### BACKGROUND OF THE INVENTION

1. Field of the Invention

The present invention relates to an improved structure for high-definition multimedia interface (“HDMI”) connector and more particularly to an improved structure for HDMI connector which can easily buckle up with any kind of sockets for HDMI connector.

2. Description of the Related Art

The way that a HDMI connector couples with a socket for HDMI connector is by simply plugging the HDMI connector into the socket for HDMI connector. However, there's no component for securing the coupling of the HDMI connector with the socket for HDMI connector. When the HDMI connector is improperly pulled by outside force, the HDMI connector would often come off from the socket for HDMI connector. Therefore, the user has to couple the HDMI connector to the socket for HDMI connector again, which is inconvenient for the user.

Therefore, the above mentioned HDMI connector presents several shortcomings to be overcome.

In view of the above-described deficiency of prior-art HDMI connector, after years of constant effort in research, the inventor of this invention has consequently developed and proposed an improved structure for HDMI connector in the present invention.

### SUMMARY OF THE INVENTION

An object of the preset invention is to provide an improved structure for HDMI connector, which uses the elasticity and the large area design of the resilient buckle plate to extend the lifetime of the resilient buckle plate, to reduce the possibility of fatigue and to reduce the complexity in manufacturing the improved structure for HDMI connector. The present invention not only extends the lifetime of HDMI connectors, but also increases the yield rate to further reduce the cost of components.

Additionally, the improved structure for HDMI connector uses a protruding portion of the resilient plate of a common socket for HDMI connector to buckle up inside a containing space with a front end of the resilient buckle plate of a HDMI connector. Therefore the present invention can be used with any kind of sockets for HDMI connector.

The present invention provides an improved structure for HDMI connector and comprises an HDMI connector having a resilient buckle plate, wherein said resilient buckle plate is embedded on a side of a HDMI connector, said resilient buckle plate has a plurality of retaining blocks disposed on a front end thereof, and said plurality of retaining blocks protrude out of said HDMI connector. Furthermore, said HDMI connector has a containing space formed in front of said resilient buckle plate for a protruding portion at a front end of a resilient plate of a socket for HDMI connector to buckle up with. When said HDMI connector is plugged into a common socket for HDMI connector and said HDMI connector goes to the deepest position inside said socket, said plurality of retaining blocks of said resilient buckle plate are buckled at an opening of said socket for HDMI connector to let said HDMI connector and said socket fixedly buckle up with each other. Besides, since the structure uses the protruding portion at the front end of the resilient plate of a traditional socket for HDMI connector to buckle up inside the containing space with a front end of the resilient buckle plate of a HDMI connector, it can be used with any kind of sockets for HDMI connector.

These features and advantages of the present invention will be fully understood and appreciated from the following detailed description of the improved structure for HDMI connector with reference to the accompanying drawings.

### BRIEF DESCRIPTION OF THE DRAWINGS

FIG. 1 illustrates a perspective view for an improved structure for HDMI connector according to the present invention;

FIGS. 2A, 2B and 2C illustrate cross sectional views of the improved structure for HDMI connector according to the present invention; and

FIGS. 3A and 3B illustrate a perspective view of how the improved structure for HDMI connector according to the present invention is coupled with a socket for HDMI connector.

### DETAILED DESCRIPTION OF THE PREFERRED EMBODIMENT

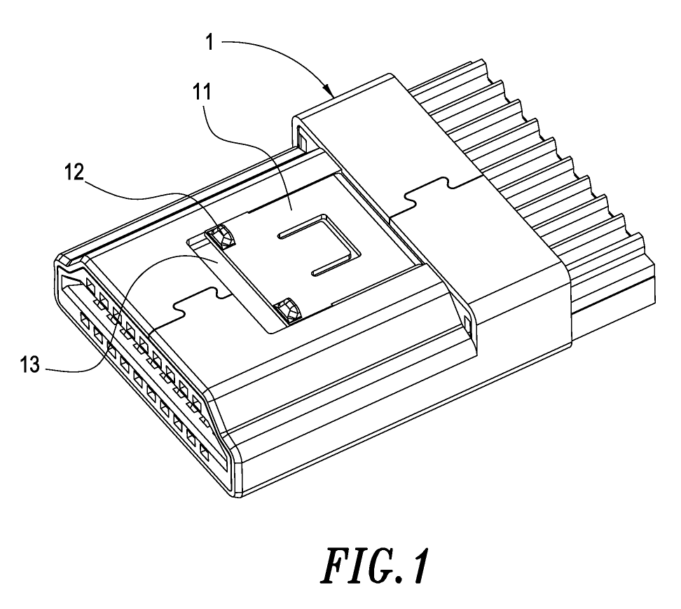

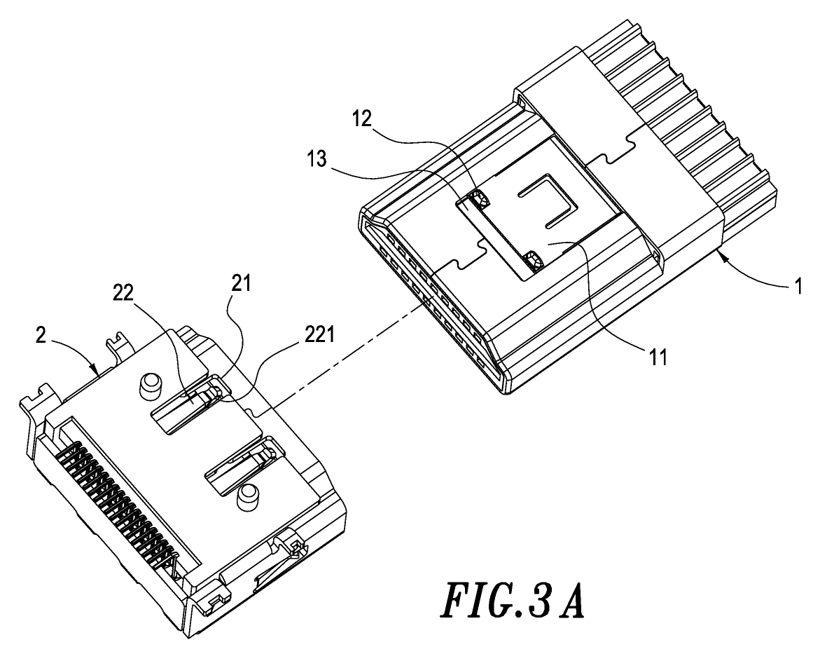

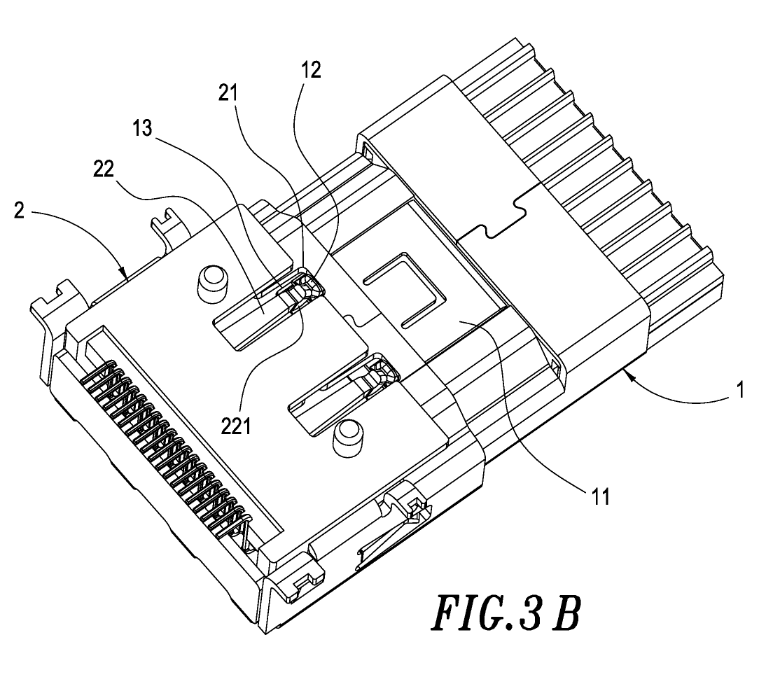

Please refer to FIGS. 1, 3A and 3B for the improved structure for high-definition multimedia interface (“HDMI”) connector disclosed in the present invention, which comprises:

an HDMI connector 1, the HDMI connector 1 having a resilient buckle plate 11 embedded at a side thereof and a containing space 13 formed in front of the resilient buckle plate 11, the resilient buckle plate 11 having a plurality of retaining blocks 12, which are disposed on a front end of the resilient buckle plate 11 and protrude out of the HDMI connector 1.

The HDMI connector 1 according to the present invention can be used with any kind of sockets 2 for HDMI connector as will be explained below.

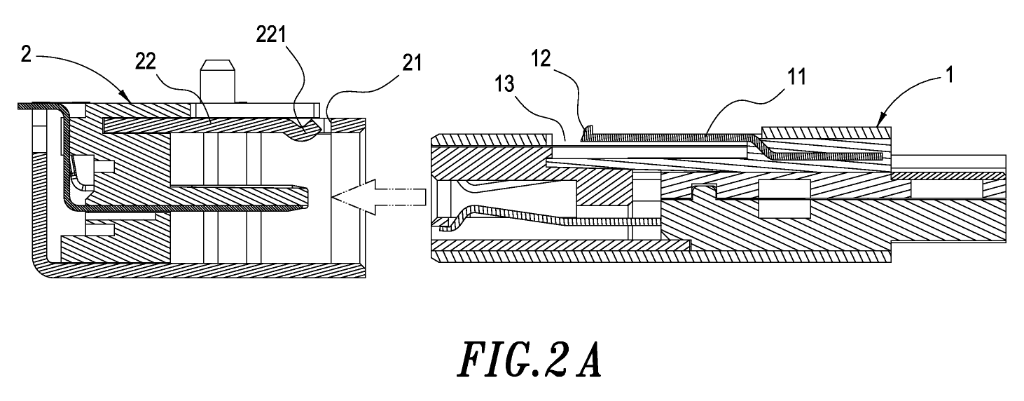

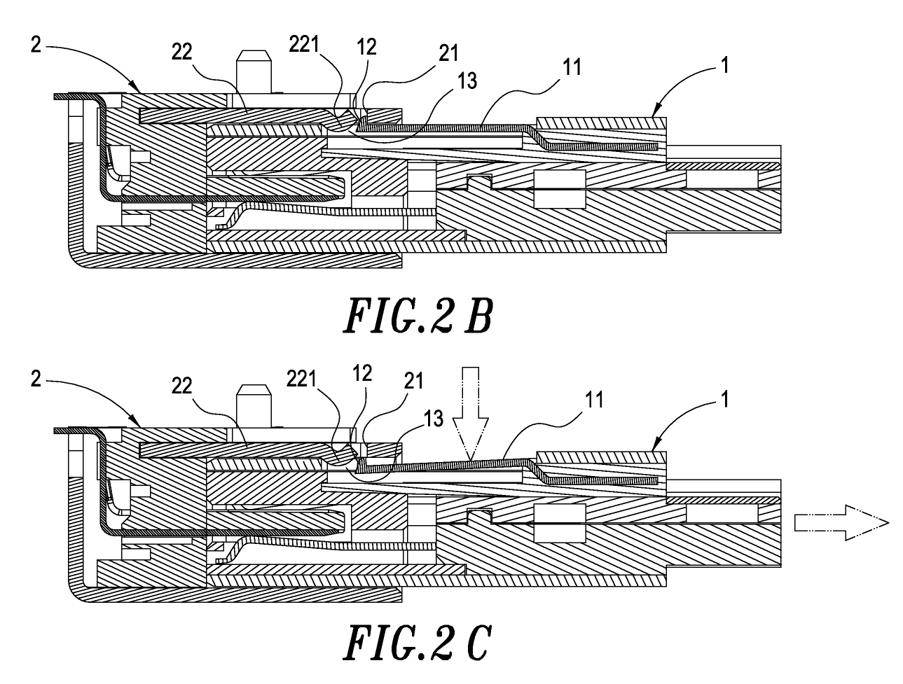

Please refer to FIGS. 2A, 2B and 2C, which illustrate cross sectional views of the improved structure for HDMI connector, wherein the HDMI connector 1 and the socket 2 for HDMI connector can be covered by a layer of rubber (not shown in figures); when the HDMI connector 1 is plugged into the socket 2 for HDMI connector (as shown in FIG. 2A) and the HDMI 1 connector goes to the deepest position inside the socket 2, the plurality of retaining blocks 12 of the resilient buckle plate 11 are buckled at an opening 21 of the socket 2 for HDMI connector, the protruding portion 221 at the front end of the resilient plate 22 of the socket 2 for HDMI connector is buckled inside the containing space 13 (as shown in FIG. 2B), and therefore the HDMI connector 1 and the socket 2 fixedly buckle up with each other. Besides, as shown in FIG. 2C, when a user wants to pull out the HDMI connector 1 from the socket 2 for HDMI connector, he/she only needs to press the resilient buckle plate 11 of the HDMI connector 1. Namely, when the resilient buckle plate 11 is forced downward, the retaining blocks 12 of the resilient buckle plate 11 will come off from the opening 21 of the socket 2 for HDMI connector, and then the user can easily pull out the HDMI connector 1 from the socket 2 for HDMI connector. Hence, the improved structure for HDMI connector is formed by using the above-mentioned components, and the improved structure for HDMI connector uses the resilience and the large area design of the resilient buckle plate 11 to extend the lifetime of the resilient buckle plate 11, to reduce the possibility of fatigue, to reduce the complexity in manufacturing the improved structure for HDMI connector and to increase the yield rate to further reduce the cost of components.

The present invention discloses an improved structure for HDMI connector which, when compared with conventional structure for HDMI connector, is advantageous in the following aspects:

1. The preset invention provides an improved structure for HDMI connector, which uses the resilience and the large area design of the resilient buckle plate to extend the lifetime of the resilient buckle plate, to reduce the possibility of fatigue and to reduce the complexity in manufacturing the improved structure for HDMI connector. The present invention not only extends the lifetime of HDMI connectors, but also increases the yield rate to further reduce the cost of components.

2. The present invention provides an improved structure for HDMI connector, which uses the protruding portion of the resilient plate of a common socket for HDMI connector to buckle up inside the containing space with a front end of the resilient buckle plate of a HDMI connector, therefore the present invention can be used with any kind of sockets for HDMI connector.

3. The present invention provides an improved structure for HDMI connector which is easy to operate and cost efficient.

Equivalent variations and modifications in the above described embodiment of the invention can, of course, be carried out without departing from the scope of the invention. Accordingly, to promote the progress in science and the useful arts, the invention is disclosed and is intended to be limited only by the scope of the appended claims.

What is claimed is:

1. An improved structure for HDMI connector, said improved structure for HDMI connector coupling an HDMI connector with a socket for HDMI connector, said improved structure for HDMI connector is characterized by:
said HDMI connector having a resilient buckle plate embedded at a side thereof, and a containing space formed in front of said resilient buckle plate, said resilient buckle plate having a plurality of retaining blocks disposed on a front end thereof.

2. The improved structure for HDMI connector of claim 1, when coupling said HDMI connector with said socket for HDMI connector, said plurality of retaining blocks of said resilient buckle plate are buckled at an opening of said socket for HDMI connector.

3. The improved structure for HDMI connector of claim 1, when coupling said HDMI connector with said socket for HDMI connector, said containing space of said HDMI connector is used for placing therein a protruding portion at a front end of a resilient plate of said socket for HDMI connector and buckling said protruding portion with said HDMI connector.
